(19) United States
(12) Patent Application Publication
(10) Pub. No.: US 2015/0149107 A1
(43) Pub. Date: May 28, 2015

(54) LOOPBACK TEST OF THE PROPER OPERATION OF TECHNICAL DEVICES IN AN INDUSTRIAL PROCESS AUTOMATION SYSTEM

(71) Applicant: ABB TECHNOLOGY AG, Zurich (CH)

(72) Inventors: Neil SHAH, Mannheim (DE); Stefan Bollmeyer, Minden (DE)

(73) Assignee: ABB TECHNOLOGY AG, Zurich (CH)

(21) Appl. No.: 14/552,031

(22) Filed: Nov. 24, 2014

(30) Foreign Application Priority Data
Nov. 22, 2013 (DE) 102013019625.6

(51) Int. Cl. G06F 11/22; H04L 12/26

(52) U.S. Cl. CPC G06F 11/2294; H04L 43/50
USPC 702/122

(57) ABSTRACT

A method and a system are disclosed for the loopback test of the proper operation of technical devices integrated in an industrial process automation system and operated by at least one electronic controller via wired or wireless connections for controlling the industrial process. The following test can be performed: a) configuring, in a device management unit having a graphical user interface, the loopback test by selecting technical devices to be included therein and specifying the test variant to be used, and b) performing, via the device management unit, the loopback test for each of the selected technical devices using the assigned test variant.

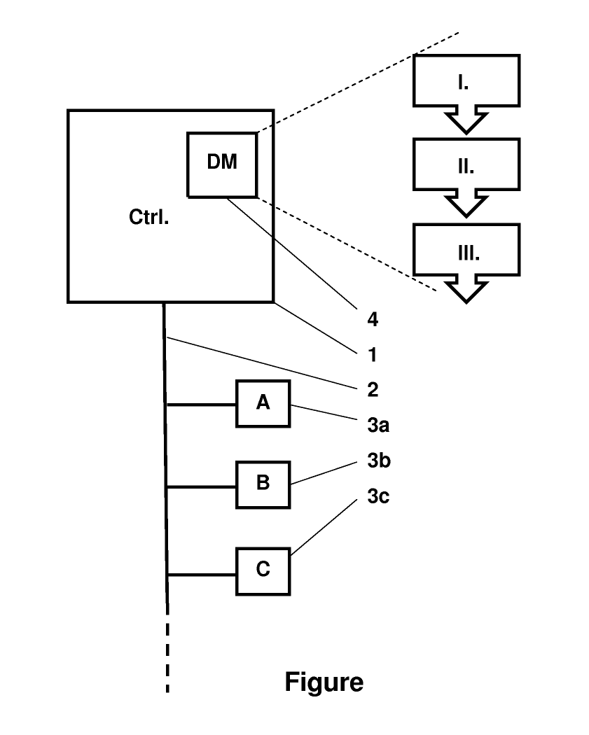

### RELATED APPLICATION

This application claims priority under 35 U.S.C. §119 to German Patent Application No. DE 102013019625.6 filed in Germany on Nov. 22, 2013, the entire content of which is hereby incorporated by reference in its entirety.

### FIELD

The disclosure relates to a method for the loopback test of the proper operation of technical devices integrated in an industrial process automation system and operated by at least one electronic controller via wired or wireless connections for the purpose of controlling the industrial process. In addition, the present disclosure also relates to an industrial process automation system having a technical implementation designed to carry out the method.

### BACKGROUND

In industrial plants, in particular in the chemicals industry, process automatic systems are used that monitor and control the production process running in the industrial plant. The technical implementation can include primarily actuators (such as valves, pump drives, final control elements and the like) and sensors (such as temperature sensors, flowmeters, pressure sensors and other measuring transducers). Despite the large variety of device types, the technical devices can be connected to standardized communications interfaces in order to communicate with at least one higher-level electronic controller. The communications channel in this case can have a wired or wireless design.

The technical devices integrated in the process automation system are embodied according to the type of communications interface as digital fieldbus devices, field devices using HART communication or analog field devices in 4-20 mA technology. In addition, there are also other standardized communications interfaces that may be used in industrial process automation systems.

Despite this diversity of device types and communications interfaces, functional tests of the technical devices must still be performed, in particular before putting a process automation system into operation or even at specified time intervals during operation, which tests are performed by a loopback test involving the central electronic controller.

According to known prior art, during a loopback test, for example of analog field devices, a test engineer must simulate directly at the technical device, which is in the off state, an electrical signal to be generated by the device, for example in steps of 4 mA to 20 mA, which signal is transferred to the higher-level electronic controller. For digital field devices, various percentage values in the range 0%-100% would be simulated, or direct measurement values in the configured measurement range. Another test engineer at the central electronic controller must confirm the received signals at the different levels, and for this purpose is in telephone contact with the other test engineer at the field device, for example via radio telephony.

Since this procedure involves a large amount of effort for each of the technical devices, the loopback test of the proper operation of the technical devices in an industrial process automation system involves a very large amount of time and labor.

The fact that the loopback test has to be performed not only for the analog field devices mentioned above by way of example but also for the field devices using HART communication that can be additionally included, and for digital fieldbus devices, means that performing the loopback test in a manner appropriate to the type increases the logistical complexity because the test variants, which are each adapted to the type of the communications interface, differ accordingly.

### SUMMARY

A method is disclosed for a loopback test of proper operation of technical devices integrated in an industrial process automation system and operated by at least one electronic controller via wired or wireless connections for the purpose of controlling an industrial process, the method comprising: a. configuring, in a device management unit having a graphical user interface, the loopback test by selecting technical devices to be included therein and specifying a test variant to be used; and b. performing, via the device management unit, the loopback test for each of the selected technical devices using the specified test variant.

An industrial process automation system is also disclosed comprising: a device management unit for a loopback test of proper operation of technical devices ntegrated in the process automation system and operated by at least one electronic controller via wired or wireless connections for controlling an industrial process; and a graphical user interface for setting up the device management unit to configure the loopback test by selecting the technical devices to be included therein and specifying a test variant to be used, and to perform the loopback test in sequence for each of the selected technical devices using the specified test variant.

### BRIEF DESCRIPTION OF THE DRAWINGS

Other features and advantages disclosed herein are presented in greater detail below with reference to the drawing in conjunction with the description of exemplary embodiments, wherein:

The single FIGURE is an exemplary block diagram of an industrial process automation system having a plurality of technical devices, which can undergo a loopback test for proper operation from a central electronic controller.

### DETAILED DESCRIPTION

The present disclosure encompasses creation of a loopback test of the proper operation of technical devices in an industrial process automation system, which loopback test enables a reliable and complete check of different types of technical devices in the process automation system within a short time.

In addition to testing the proper operation of the device as such, the test also can include testing the correct configuration for the intended use and whether the process value in the controller matches the same process value in the device.

Exemplary embodiments can include a process engineering feature whereby in a device management unit having a graphical user interface, which is for example, part of the central electronic controller of the process automation system, first a loopback test is configured by selecting technical devices to be included therein and specifying a test variant to be used, on the basis of which the device management unit performs the loopback test for each of the selected technical devices using the assigned test variant.

An exemplary advantage of a solution according to the present disclosure is, for example, that the loopback test of the proper operation of all the technical devices can be performed by a single test engineer from a central point. This means that mistake-prone communication by telephone with other test engineers can be dispensed with. In an exemplary solution according to the present disclosure, the device management unit causes the technical device to simulate the values to be transmitted by using different types of device drivers. This can reduce considerably the time needed for the full loopback test of all the technical devices integrated in a process automation system while also reducing the labor costs for the loopback test.

According to a further feature of the disclosure, for the purpose of configuring the loopback test, access can be made by software to engineering data of the process control system in order to obtain therefrom the setpoint values for the test steps.

According to a further measure, the device management unit can create and output a report on the positive or negative result of the loopback test of the proper operation for each of the selected and tested devices. The report can here contain, in addition to the information on the passing or failing of the test for each technical device, also information about the time and date of the test, about the physical test status and the like.

The loopback test can for example, be performed in accordance with a defined test sequence for the selected technical devices. This means that testing of the operation of a device can be performed device by device according to the assigned test variant. For example, devices of the same type, such as for instance only analog field devices, are tested in one test run, which devices can be selected in advance in appropriate groups. As an alternative to this, it is also possible to perform the loopback test only for one device type, for example for all measuring transducers. Exemplary embodiments can be implemented in the form of a software program product containing control instructions for performing the method described herein, wherein the control instructions are stored on a data storage medium that can be connected to the device management unit of the industrial process automation system for the purpose of data transfer. In this case, the data storage medium can be in the form of a portable storage medium or a server integrated in a communications network.

According to the FIGURE, in a process automation system (which is shown generally) a central electronic controller 1 is arranged, from which a plurality of technical devices 3a to 3c can be operated via a wired connection 2 for the purpose of controlling the industrial system. In this exemplary embodiment, the technical devices 3a to 3c are analog field devices using 4-20 mA technology as the communications interface and are embodied as measuring transducers as regards type of device. In addition, there are also further technical devices (generally shown in greater detail) of a different device type in the process automation system.

The electronic controller 1 can contain a device management unit 4, which, like the electronic controller 1, can be in the form of a software-controlled processor. The device management unit 4 in the form of a processor executes inside the electronic controller 1 control instructions that include, inter alia, a loopback test of the proper operation of the technical devices 3a to 3c.

According to an exemplary embodiment, the control instructions, initiated by the device management unit 4 via the communications interface, can be executed in the devices 3a to 3c. This advantageously enables simulation of process values in the devices 3a to 3c.

In a first test step I, the loopback test is configured by selecting the technical devices 3a to 3c to be included therein and specifying the test variant to be used, in this case an analog device functional test for analog devices 3a to 3c in 4-20 mA technology. For intelligent devices 3a to 3c using digital communication, the test value can be written from the controller 1 into the device. For analog devices 3a to 3c, the device management unit 4 is connected directly to the device 3a to 3c in order to define the test values.

For this purpose, the current level steps 4, 8, 12, 16, 20 mA can be selected in increasing and decreasing order a device instance for the loopback test, in this case all measuring transducers. In addition, a report format can be selected, which outputs the outcome of the loopback test, including result, date, user and the like.

In a subsequent execution II of the loopback test by the device management unit 4, the previously selected test variant is performed for each technical device 3a to 3c. In this procedure, each current step is simulated for approximately 5 seconds for example, and the result is recorded by the device management unit 4. This procedure is repeated for each previously selected technical device 3a to 3c. A “SQUAWK check” can optionally be performed if the technical device 3a supports this check and if a person can be present at the location of the technical device 3a. The result is provided by an information output directly at the technical device 3a. The technical device 3a can be switched into a simulation mode by means of the device driver. Then the value is set to the first level of 4 mA, for example. The device driver is then used to measure the simulated value. If the measured value equals the simulated value within a predetermined time period of, for example, 5 seconds after initiating the simulation, then this test step is assessed as “passed”.

The device management unit 4 then changes to the next higher current level and the procedure is repeated. When the test has run through all the current steps successfully, the loopback test of the technical device 3a is identified as “passed”, otherwise as “failed”. Then the loopback test moves automatically to the next selected technical device 3b, and the test is performed there. Once the last technical device 3c has been tested in this way, the loopback test of the proper operation of the selected technical devices 3a-3c has finished.

As the next step, the device management unit 4 outputs a report III about the positive or negative result of the loopback test. The report contains the information about the passing or failing of all tested technical devices, about the user who has performed the loopback test, the time and date of the loopback test and the physical test status.

These functions can also be performed from a portable apparatus instead of a device management unit permanently implemented in the electronic controller 1, which apparatus can communicate wirelessly with the controller and carry out the loopback test.

The invention is not limited to the preferred exemplary embodiments described herein. In fact variants of the exemplary embodiments are also possible are covered by the scope of protection of the following claims. For instance it is also possible to test technical devices that use a different communications interface, for example field devices using HART communication, or digital fieldbus devices. In these cases, for example, a test variant must be chosen that uses a test protocol that is designed to suit the communications interface and the type of the technical device. The appropriate preselection can be made manually or automatically by the device management unit 4.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCES

1 electronic controller
2 connection
3 technical device
4 device management unit
I configuration of the loopback test
II execution of the loopback test
III result report of the loopback test

1. A method for a loopback test of proper operation of technical devices integrated in an industrial process automation system and operated by at least one electronic controller via wired or wireless connections for the purpose of controlling an industrial process, the method comprising:
a. configuring, in a device management unit having a graphical user interface, the loopback test by selecting technical devices to be included therein and specifying a test variant to be used; and
b. performing, via the device management unit, the loopback test for each of the selected technical devices using the specified test variant.

2. The method as claimed in claim 1, comprising:
Creating and outputting, via the device management unit, a report on a positive or negative result of the loopback test of the proper operation for each of the selected and tested devices.

3. The method as claimed in claim 1, comprising:
performing the loopback test in accordance with a defined test sequence for the selected technical devices.

4. The method as claimed in claim 1, wherein in the configuration of the loopback test, only technical devices that are the same in terms of a communications interface and/or device type are selected for a loopback test run.

5. An industrial process automation system comprising:
a device management unit for a loopback test of proper operation of technical devices integrated in the process automation system and operated by at least one electronic controller via wired or wireless connections for controlling an industrial process;
and a graphical user interface for setting up the device management unit to configure the loopback test by selecting the technical devices to be included therein and specifying a test variant to be used, and to perform the loopback test in sequence for each of the selected technical devices using the specified test variant.

6. The industrial process automation system as claimed in claim 5, wherein the technical devices of the process automation system are selected with regard to device type from a group of actuators and sensors that includes final control elements, valves, measuring transducers.

7. The industrial process automation system as claimed in claim 5, wherein the technical devices of the process automation system are selected with regard to a communications interface from a group that includes digital fieldbus devices, field devices using HART communication, and analog field devices using 4-20 mA technology.

8. The industrial process automation system as claimed in claim 5, wherein the test variant is selected from a group that includes an analog device functional test, a HART device functional test, and a fieldbus device functional test.

9. A software program product containing control instructions for performing the method as claimed in claim 1, wherein the control instructions are stored on a non-transistory data storage medium configured for connection to a device management unit of an industrial process automation system for data transfer.

10. The software program product as claimed in claim 9, wherein the data storage medium is a portable storage medium or a server integrated in a communications network.
